(19) United States
(12) Patent Application Publication
(10) Pub. No.: US 2026/0030673 A1
(43) Pub. Date: Jan. 29, 2026

(54) ACCESS CONTROL OF AN ELECTRONIC EXCHANGE NETWORK

(71) Applicant: Cboe Exchange, Inc., Chicago, IL (US)

(72) Inventors: Bryan Blake, Toronto (CA); Vincent Poil, Toronto (CA)

(21) Appl. No.: 19/347,493

(22) Filed: Oct. 1, 2025

Related U.S. Application Data
(63) Continuation of application No. 18/181,810, filed on Mar. 10, 2023.
(60) Provisional application No. 63/318,983, filed on Mar. 11, 2022.

(51) Int. Cl. G06Q 40/04

(52) U.S. Cl. CPC G06Q 40/04

(57) ABSTRACT

Implementations provide an exchange computer system including at least one communication interface connecting a plurality of remote computing devices with the exchange computer system; a matching engine comprising at least one hardware processor configured to perform operations of: receiving, from a remote computing device, data encoding a first conditional transaction request; identifying a second transaction request that is a likely match for the first conditional transaction request when the first conditional transaction request is at least partially met by the second transaction request; transmitting, to the remote computing device, data encoding an invitation for the submitting user to firm up the first conditional transaction request; and responsive to receiving a reply indicating that the submitting user firms up the first conditional transaction request, executing the first conditional transaction request and the second transaction request such that the exchange computer allows the submitting user to conduct exchanges with algorithm-driven agents.

### CROSS-REFERENCE TO RELATED APPLICATION

This application is a continuation of U.S. application Ser. No. 18/181,810, filed Mar. 10, 2023, which claims the benefit of U.S. Provisional Patent Application No. 63/318,983 filed Mar. 11, 2022, which is incorporated herein by reference in its entirety.

### TECHNICAL FIELD

This application relates to technology for access control in electronic exchanges using high-speed networks with minimal latencies.

### BACKGROUND

High volumes of electronic exchanges of electronic objects such as financial instruments (e.g., derivatives, stocks, and bonds) are continuously executed at electronic exchanges, which enable electronic exchanges to occur in real time through the algorithmic processing of transaction requests (e.g., orders) and associated market information. Generally, an exchange may be executed when the price associated with a bid to purchase a financial instrument matches the price associated with an offer to sell the same instrument when, the bidding and offering prices are sufficiently close. Market participants typically price their bids and offers based on market conditions, which are subject to rapid change, and electronic exchanges often match bids and offers based on price-time priority, and the principle of first-in, first-out (FIFO).

### SUMMARY

In an electronic or hybrid exchange environment, many thousands of transactions are executed each second, and unforeseen events occur frequently. Market participants can greatly benefit from enhanced control and flexibility over their orders to avoid losses when these unforeseen events occur. Sophisticated market participants in possession of specialized software and hardware can, for example, operate as an algorithm-driven software agent (e.g., algorithm trader) capable of electronically leveraging market intelligence to inform decisions that outpace competing algorithm-driven software agents (e.g., other algorithm traders). Such fast-paced trading strategies can involve various complex order types made available on modern electronic exchanges. In this electronic environment, however, not all participants enjoy the technological means and knowledge possessed by institutional players. Thus, designing the exchange network to provide access control for average human players to fully participate in the typically complicated process of exchanging financial instruments is a technical problem.

The disclosed implementations can provide a technical solution to the aforementioned technical problem by improving the human-machine inter-operability of the exchange network such that human players and non-human software agents can seamlessly co-exist to boost participation while preserving fairness to both. As a form of access control, the implementations provide an open system that accommodates the diverging capabilities expected from human and non-human participants. For example, participants, regardless of a human player (e.g., sponsored user) or a non-human software agent (e.g., a subscriber) can enter passive conditional orders that allow the participant to send a potential order that sits uncommitted until the party is invited—and accepts—to “firm up” the order. This invitation to “firm up” is transmitted to the party when a contra liquidity is found, for example, on the exchange network. The contra liquidity can refer to an order for the underlying asset (e.g., a financial instrument) in reverse direction that meets the price limit and at least partially fulfills the volume of the conditional order. The order of contra liquidity may be a conditional order. Additionally or alternatively, the order of contra liquidity may be a firm order, for example, a market order. In the latter case, the subscriber, or the sponsor, has opted into the exchange network to reap the benefits of the conditional orders.

The implementations may improve the performance of a large-scale trading network, as measured in atomic execution of each transaction while preserving system-level fairness. Each conditional order may sit uncommitted, until the party is invited—and accepts—to “firm up” the order. When a contra liquidity has been identified, the implementations use synchronized communication to transmit the invitation back to the party who placed the conditional order to firm-up. In this synchronized communication, the exchange network may wait for the party of the conditional order to respond so that no other party may access the identified contra liquidity in the interim. Because human traders and non-human (e.g., algorithm) traders vary in realistic responsiveness, implementations may use different time-out values. For example, when the communication is between a sponsored user (i.e., a human player) and another sponsored user (i.e., another human player), the time-out may be set at 30 seconds for both parties to firm-up. When the communication is between a subscriber (i.e., an algorithm trader) and another subscriber (i.e., another algorithm trader), the time-out may be set at 1 second for both sides. This differentiation of the time-out value for synchronized communication can ensure the contra liquidity is not over-committed and the trade, when executed, takes place over the contra liquidity still available. In other words, the judicious implementation of the time-out mechanism, along with the use of synchronized communication, provide an atomic execution of the requested transaction, much like the transaction enforcement on a modern database management system (DBMS). For context, an atomic transaction in the database context refers to an indivisible and irreducible series of operations such that either all occurs, or nothing occurs, which prevents updates to a data entry occurring only partially, which can cause greater problems than rejecting the whole series outright. Here, atomicity is likewise achieved with respect to the identified contra liquidity. Moreover, the differentiation of time-out periods can accommodate both players so that market fairness can be achieved at the system level.

The implementations can incorporate a compliance mechanism to mitigate information leakage while discouraging/minimizing potentially abusive conduct by a participant but without undermining fair access to the matching capabilities of the exchange network. For example, each subscriber (i.e., non-human algorithm trader) or sponsored user (i.e., human trader) that receives 10 or more invitations to firm up an order with a conditional specification for a given security needs to avoid crossing below, for example, a threshold level of firm-ups for that security. In many cases, the threshold may be around 70%. When a subscriber (i.e., non-human algorithm trader) or a sponsored user (i.e., human trader) fail this threshold level, the subscriber or sponsored user may be suspended from receiving invitations for new order with a conditional specification that the party enters for that security for the rest of that trading day. Notably, a fallen-down order with a conditional specification that originate with a sponsored user may not be attributed to the sponsor (e.g., a large brokerage company) for the conditional specification for purposes of calculating the sponsor's fall-down rate, but rather, these occurrences will be exclusively attributed to the sponsored user that entered the orders into the system. Moreover, daily suspensions of subscribers (including which symbols were affected by the suspension) may be reported to a supervising agency and to each affected subscriber in real time, for example, via email, SMS, or other instant messaging tools. Moreover, statistics of conditional execution may be reported to an oversight board, or the public, for book keeping purposes.

For example, various implementations may leverage a messaging protocol such as the FIX (Financial Information exchange) protocol, which an electronic messaging protocol used by financial institutions to facilitate electronic communication for trading and other activities in the financial markets. The protocol defines a set of rules and guidelines for exchanging real-time market data, trading instructions, and other financial information between different parties. FIX messages may be sent in a specific format, which includes a message header, body, and trailer. The header contains information about the sender and receiver, while the body contains the actual message data. The trailer includes a checksum to ensure the message's integrity. The typical range of volume of FIX messages on a high-speed exchange network can vary widely depending on a number of factors, such as the type of trading activity, the number of participants, and the level of market volatility. However, in many cases, a high-speed exchange network can operate to process millions of FIX messages per second during peak trading periods. Indeed, operating FIX protocol on high-speed exchange networks can achieve low latencies in the range of microseconds or nanoseconds to allow market participants to execute trades quickly and efficiently in rapidly changing market conditions. As trading activity and market complexity continue to grow, exchange networks and market participants are continually working to optimize FIX messaging systems and protocols to support even higher volumes of data and faster processing speeds.

As described in more detail within the following disclosure, an exchange computer system can be implemented in a manner enabling it to dynamically, efficiently, and continuously manage access control of conditional transaction requests.

In one aspect, implementations provide an exchange computer system that includes: at least one communication interface connecting a plurality of remote computing devices with the exchange computer system, wherein an algorithm-driven software agent drives at least one of the plurality of remote computing devices to exchange one or more electronic objects using the exchange computer system; a matching engine comprising at least one hardware processor, and at least one non-transitory computer-readable medium coupled to the at least one hardware processor and configured to store software instructions that, when executed by the at least one hardware processor, cause the at least one hardware processor to perform operations comprising: receiving, from a remote computing device with a graphical user interface (GUI), data encoding a first conditional transaction request for exchanging the one or more electronic objects in a first direction, wherein the GUI captures one or more user inputs by a submitting user that determine the data encoding the first conditional transaction request; identifying, based on the first conditional transaction request for exchanging the one or more electronic objects in the first direction, a second transaction request for exchanging the one or more electronic objects in a second direction that is reverse to the first direction; determining that the second transaction request is a likely match for the first conditional transaction request when the first conditional transaction request is at least partially met by the second transaction request; transmitting, to the remote computing device, data encoding an invitation for the submitting user to firm up the first conditional transaction request; and responsive to receiving, from the remote computing device, a reply to the invitation indicating that the submitting user firms up the first conditional transaction request on the GUI, executing the first conditional transaction request and the second transaction request such that the exchange computer system allows the submitting user to exchange the one or more electronic objects with the algorithm-driven software agent despite varied responsiveness.

Implementations may include one or more of the following features.

The matching engine may be configured to perform additional operations of: in response to a size of the first conditional transaction request being larger than a corresponding size of the second transaction request, preparing to execute the first conditional transaction request as partially fulfilled. The matching engine may be further configured to perform additional operations of: identifying a third transaction request for exchanging the one or more electronic objects in the second direction that is reverse to the first direction.

The matching engine is configured to perform additional operations of: determining that the third transaction request is a likely match for a remainder of the first conditional transaction request when the remainder of the first conditional transaction request is at least partially met by the third transaction request; transmitting, to the remote computing device, data encoding an invitation for the submitting user to firm up the remainder of the first conditional transaction request; and responsive to receiving a reply to the invitation from the remote computing device indicating that the submitting user firms up the remainder of the first conditional transaction request, executing the remainder of the first conditional transaction request and the third transaction request.

The matching engine is configured to perform additional operations of: in response to a size of the first conditional transaction request being smaller than a corresponding size of the second transaction request, identifying a third transaction request for exchanging the one or more electronic objects in the first direction.

The matching engine may be configured to perform additional operations of: transmitting, to the remote computing device, data encoding the invitation for the submitting user to firm up the first conditional transaction request, until a reply to the invitation is received from the remote computing device, or a time-out is reached. The matching engine may be further configured to adjust the time-out depending on identities of the submitting user of the first conditional transaction request and a submitting party of the second transaction request. The time-out may include a period of thirty seconds when the first conditional transaction request is not initiated by an algorithm-driven software agent. The time-out may include a period of one second when both the submitting user of the first conditional transaction request and the submitting party of the second transaction request are initiated by algorithm-driven software agents.

The matching engine may be further configured to perform additional operations of: conducting a set of risk control tests prior to executing the first conditional transaction request and the second transaction request. The set of risk control tests may include: a fat-finger check, a single order limit, a traded value limit, and a cumulative daily traded value limit.

In another aspect, implementations may provide a computer-implemented method comprising: receiving, from a remote computing device with a graphical user interface (GUI), data encode a first conditional transaction request for exchanging one or more electronic objects in a first direction, wherein the GUI captures one or more user inputs by a submitting user that determine the data encoding the first conditional transaction request; identifying, based on the first conditional transaction request for exchanging the one or more electronic objects in the first direction, a second transaction request for exchanging the one or more electronic objects in a second direction that is reverse to the first direction; determining that the second transaction request is a likely match for the first conditional transaction request when the first conditional transaction request is at least partially met by the second transaction request; transmitting, to the remote computing device, data encoding an invitation for the submitting user to firm up the first conditional transaction request; and responsive to receiving, from the remote computing device, a reply to the invitation indicating that the submitting user firms up the first conditional transaction request on the GUI, executing the first conditional transaction request and the second transaction request such that the submitting user can use conditional transaction requests to exchange the one or more electronic objects over an exchange computer system shared with an algorithm-driven software agent.

Implementations may include one or more of the following features.

The method may further include: in response to a size of the first conditional transaction request being larger than a corresponding size of the second transaction request, preparing to execute the first conditional transaction request as partially fulfilled. The method may further include: identifying a third transaction request for exchanging the one or more electronic objects in the second direction that is reverse to the first direction. The method may further include: determining that the third transaction request is a likely match for a remainder of the first conditional transaction request when the remainder of the first conditional transaction request is at least partially met by the third transaction request; transmitting, to the remote computing device, data encoding an invitation for the submitting user to firm up the remainder of the first conditional transaction request; and responsive to receiving a reply to the invitation from the remote computing device indicating that the submitting user firms up the remainder of the first conditional transaction request, executing the remainder of the first conditional transaction request and the third transaction request.

The method may further include: in response to a size of the first conditional transaction request being smaller than a corresponding size of the second transaction request, identifying a third transaction request for exchanging the one or more electronic objects in the first direction.

The method may further include: transmitting, to the remote computing device, data encoding the invitation for the submitting user to firm up the first conditional transaction request, until a reply to the invitation is received from the remote computing device, or a time-out is reached. The method may further include: adjusting the time-out depending on identities of the submitting user of the first conditional transaction request and a submitting party of the second transaction request. The time-out may include a period of thirty seconds when the first conditional transaction request is not initiated by an algorithm-driven software agent. The time-out may include a period of one second when both the submitting user of the first conditional transaction request and the submitting party of the second transaction request are initiated by algorithm-driven software agents.

The details of one or more embodiments of the subject matter described in this specification are set forth in the accompanying drawings and the description below. Other potential aspects, features, and advantages will be apparent from the description, the drawings, and the claims.

### BRIEF DESCRIPTION OF THE DRAWINGS

FIG. 1 is an example diagram of an exchange computer system according to some implementations of the present disclosure.

FIG. 2 is another example diagram of an exchange computer system according to some implementations of the present disclosure.

FIG. 3A is an illustration of an exemplary graphical user interface for asserting conditional specifications in an exchange computer system according to some implementations of the present disclosure.

FIG. 3B is another illustration of the exemplary graphical user interface for implementing conditional specifications in an exchange computer system according to some implementations of the present disclosure.

FIG. 4 is diagram illustrating an example of access control in an exchange computer system according to some implementations of the present disclosure.

FIG. 5 is a flowchart of an example of a process according to some implementations of the present disclosure.

FIG. 6 is a flowchart of an example of a process according to some implementations of the present disclosure.

### DETAILED DESCRIPTION

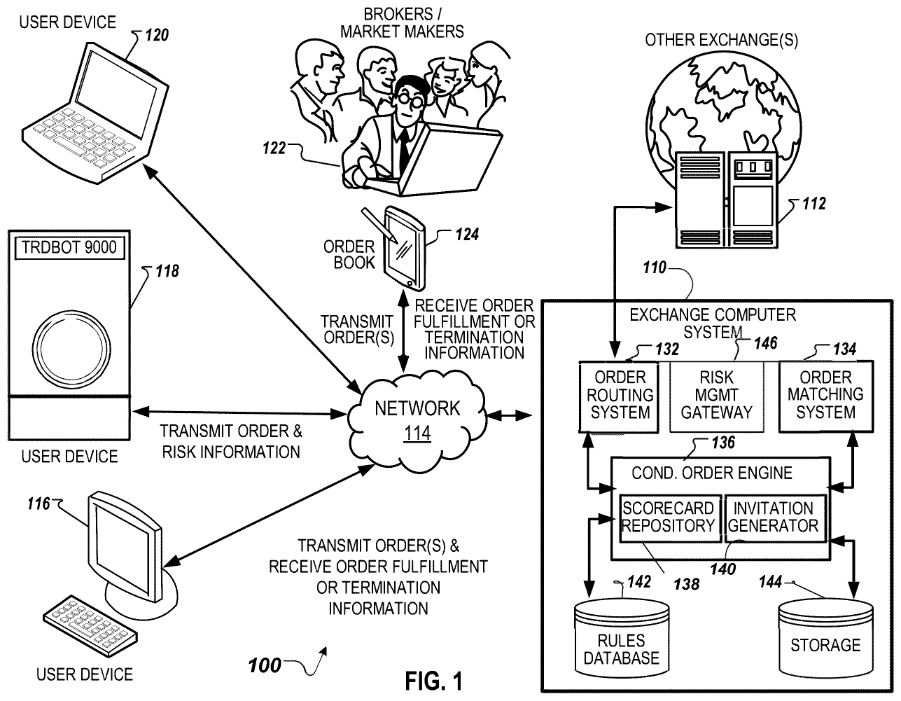

FIG. 1 is an example diagram of an exchange computer system and the associated networks, devices, and users that make up an exemplary trading environment in which the exchange computer system operates. The diagram includes an exchange computer system 110, other exchanges 112, a network 114, user devices 116, 118, 120, market makers/brokers 122, and an electronic order book 124. Generally, the term “user” can refer to any entity that interacts with the exchange computer system and/or associated networks and devices. Users can include, for example, market makers, market participants, brokers, institutional traders, individual traders, and automated trading systems. In some examples, the user device 118 can be a non-human algorithmic trader. In some examples, users 116 and 118 can be human traders.

In some examples, a user can be refer to as a member, as defined under exchange rules, or a clearing member, who is a member of a Qualified Clearing Agency authorized to clear transactions on behalf of another member, as defined under exchange rules. If a clearing member is the user, the clearing member can be required to request authorization from the exchange computer system 110 to receive data indicative of a current or previous risk profile setting of the member on behalf of whom the clearing member is acting.

The exchange computer system 110 may be implemented in a fully electronic manner, or in a hybrid manner that combines electronic trading with aspects of traditional open-outcry systems. The exchange computer system 110 may receive orders for trading financial instruments locally on the floor and from remote electronic devices. The financial instruments may include securities such as stocks, options, futures contracts, or other derivatives associated with an underlying asset. The underlying asset, also referred to as “the asset”, may be any financial instrument, e.g., stock, option, any number of financial instruments, e.g., stock market index, or some combination therein.

The orders received and processed by the exchange computer system 110 can include conditional orders and firm orders. Conditional orders are orders to buy or sell a financial instrument when conditions specified by the user are satisfied. Conditional orders can include limit orders and stop orders. A limit order is an order to automatically buy or sell a financial instrument at a maximum bid price to be paid or at a minimum offer price to be received, as specified by the user. A stop order is an order to buy or sell when the financial instrument's market price has reached or surpassed the user's requested price. Limit orders and stop orders can be placed above and below the market price. Conditional orders disclosed herein can also prevent features or metrics of an order, such as price, volume, value, and the like from becoming known to users outside of the conditional order system. In contrast to conditional orders, a firm order is not dependent upon a later confirmation by the market participant. For example, a firm order can be placed on behalf of a firm (rather than a firm's client) and is not dependent upon a later confirmation by the client or conditions set by the client.

Network 114 connects the various components within the trading environment, and may be configured to facilitate communications between those components. Network 114 may, for example, be configured to enable the exchange of electronic communications that include order and order fulfillment information between connected devices, such as an electronic order book 124 and the exchange computer system 110.

Network 114 may include one or more networks or subnetworks, each of which may include a wired or wireless data pathway. Network 114 may, for example, include one or more of the Internet, Wide Area Networks (WANs), Local Area Networks (LANs), or other packet-switched or circuit-switched data networks that are capable of carrying electronic communications (e.g., data or voice communications).

In some implementations, the network 114 can include a communications network inclusive of hardware and software implemented on various systems, devices, and components connected to network 114. In some implementations, trader information, such as a trader's speech and actions, can be recorded by a user device (e.g., a computer or portable device such as a cellular phone) at the location of the trader using sensors, cameras and microphones, and can be continuously transmitted across the network 114 to other devices connected to the network 114.

To protect communications between the various systems, devices, and components connected to network 114, network 114 may implement security protocols and measures such that data identifying order or bid information, or parties placing orders or quotes, may be securely transmitted. Network 114 may, for example, include virtual private networks (VPNs) or other networks that enable secure connections to be established with exchange computer system 110.

User devices 116, 118, and 120 can include portable or stationary electronic devices, such as smartphones, laptops, desktops, and servers that include user interfaces to display information and receive user input, and that are configured to communicate over a computer network. User devices 116, 118, and 120 can communicate with the exchange computer system 110 over network 114 using a proprietary protocol, or a message-based protocol such as financial information exchange (FIX), implemented over TCP/IP. The user devices 116, 118, and 120 may include or be coupled to one or more user interfaces such as a keyboard, mouse, or display device through which user input, such as user selections, can be received. For example, a display device in a user device 116, 118, or 120 can be configured to display a web portal or graphical user interface through which a user can provide input related to a conditional order.

User devices 116, 118, and 120 can transmit user input such as order information, including any conditional orders, to the exchange computer system 110, and can also receive data from the exchange computer system 110 indicating that an order has been filled or canceled. The data can be conveyed in various suitable ways including, for example, in the form of a report providing details of a trade or cancellation. The details in the report can include one or more of the parties or firms involved, the financial instrument being traded, the price and quantity of the trade, the time at which the trade was completed or canceled, and the venue of the exchange at which the trade was executed or canceled. In some implementations, one or more details of the report can be sanitized or anonymized such that the one or more details (e.g., parties involved in the trade, volume traded, or value of the trade) of the report are omitted from the report.

Users, such as brokers/market makers or market participants 122, can also place orders and receive information about order fulfillment or termination through electronic order book 124, which can include a record of outstanding public customer limit orders that can be matched against future incoming orders.

The exchange computer system 110 includes an order entry port (not shown), an order routing system (ORS) 132, an order matching system (OMS) 134, a conditional order engine 136, a database 142 of trading rules and algorithms, storage 144, and a risk management gateway 146. The conditional order engine 136 includes a market participant (MP) scorecard repository 138 and an invitation generator 140. The exchange computer system 110 can be integrated at a single location or a single device, e.g., in the form of a server, or can be distributed over a wired or wireless computer system.

The order routing system (ORS) 132 determines whether a received order or quote is to be executed at the exchange computer system 110, or should instead be redirected to another exchange 112, and may include processing systems that enable the management of high data volumes. The ORS 132 may, for example, receive order or quote information for the purchase or sale of financial instruments from one or more user devices 116, 118, 120, and 124. In some implementations, the ORS 132 may also be connected to or include a touch-screen order routing and execution system accessible by brokers on the exchange floor, such as a public automated routing (PAR) system.

Upon receiving an order or quote, the ORS 132 determines if the destination specified in the received order or quote is the exchange computer system 110. If the exchange computer system 110 is not the destination, the ORS 132 forwards the order or quote to another exchange 112, which may be either the destination exchange, or an exchange en route to the destination exchange. If the ORS 132 determines that the exchange computer system 110 is the destination of the received order or quote, the ORS 132 may forward the received order or quote to the order matching system 134.

If the ORS 132 determines that the exchange computer system 110 is the destination of the received order or quote, the ORS 132 can forward the received order or quote to the OMS 134. The ORS 132 can include or be coupled to an order entry port that receives the order and forwards the received order to the OMS 134. In some implementations when processing conditional orders, the ORS 132 is configured to route a conditional order according to a destination associated with the first conditional order.

The OMS 134 includes processing systems that analyze and manipulate orders according to matching rules stored in the database 142. The OMS 134 can also include an electronic book (EBOOK) of orders and quotes with which incoming orders to buy or sell are matched, according to the matching rules. The EBOOK can also be implemented in a separate database such as storage 144, which can include multiple mass storage memory devices for the storage of order and quote information. When the OMS 134 determines that a match exists for an order (for example, when a bid matches an offer for sale), the OMS 134 can mark the matched order or quote with a broker-specific identifier so that the broker sending the order or quote information can be identified.

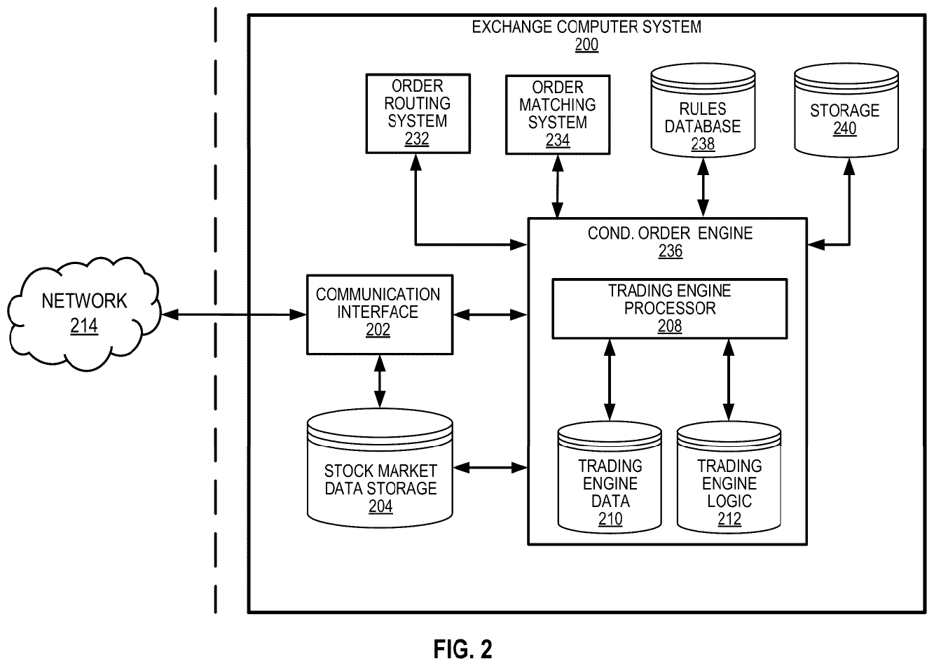

The conditional order engine (COE) 136 may be implemented using a combination of software and hardware. The COE 136 may, for example, be implemented as one or more hardware processors configured to execute one or more algorithms, as described in further detail below. An exemplary configuration of an exchange computer system featuring a COE 136 for conduct trading is further described in FIG. 2.

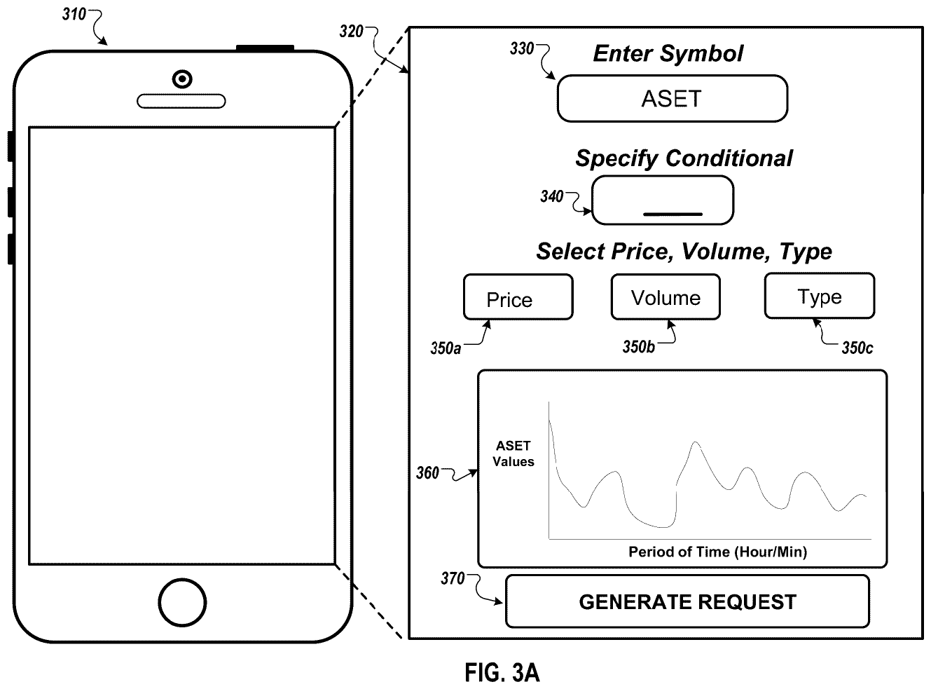

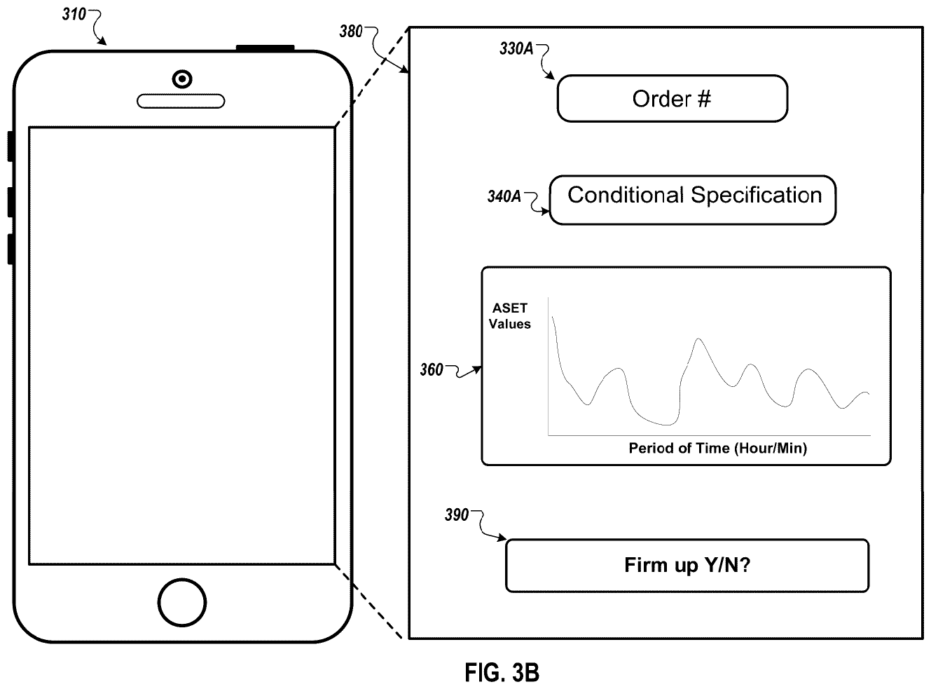

The COE 136 may implement access control based on information received from one or more networked user devices. The COE 136 may implement access control for transaction requests with conditionals by following processes further described, for example, with respect to FIGS. 3A, 3B, 4, and 5. After receiving conditional specifications for executing a given transaction request, the trading engine 136 may notify other exchanges (e.g., exchanges 112) and one or more user devices (e.g., user devices 116, 118, 120) of generation of the pending transaction request and associated conditional specifications using network 114.

In some implementations, one or more parts of the conditional order engine 136 can be integrated with other parts of the exchange computer system 110. For example, the MP scorecard repository 138 can be implemented within storage 144, which could be integrated with or coupled to the conditional order engine 136. In some implementations, a processor of the conditional order engine 136 may be integrated with or coupled to one or more processors of the exchange computer system 110 such as a processor of the ORS 132 and/or OMS 134. The conditional order engine 136 can be coupled to one or more user interfaces such as a keyboard, mouse, or display device.

The MP scorecard repository 138 is a database in which the scorecards for the various users of the exchange computer system 110 are stored. A scorecard can be generated for each user and is representative of the aggregate score for each user. A user can be scored based on a trading performance of the user. If a user has a strong record of filling orders and following market participant rules, obligations, and protocols, the user receives positive scores. In contrast, if a user has a weak record of filling orders and following market participant rules, obligations, and protocols, the user receives negative scores.

As an example, if a user has placed a conditional order, but at the time a match for the conditional order is found, can no longer fill the order, e.g., due to insufficient volume or available funds, the user will receive a negative score. In contrast, if the user places a conditional order and is able to convert the conditional order to a firm order and execute the order, the user will receive a positive score.

Different scores can be assigned to users based on the type of action, transaction, or violation. For instance, a user who completes a high volume or value trade may receive a higher positive score than a user who completes a lower volume or value trade. A user who completes a firm order may receive a first score (which can be implemented in the form of points) as the user's score. A user who completes a trade based originally from a conditional order may receive a second score (e.g., second number of positive points) that is different from the first score (e.g., first number of positive points). The first score and second score may be determined at the conclusion of the transaction before the report is compiled. The first score and second score may be stored in the electronic exchange system and associated with their respective users.

The MP scorecard repository 138 includes a conditionals compliance mechanism. Should the first or second user cancel their respective conditional orders, the cancelation is reported to the conditionals compliance mechanism and stored in the MP scorecard repository 138. The conditionals compliance mechanism determines whether the score of the first and second users have fallen below the minimum scorecard threshold level. If the score falls below the minimum scorecard threshold level, the conditionals compliance mechanism suspends trading by either or both of the first and second user. In at least one example, the score is based upon a firm-up ratio, i.e., a ratio indicating a percentage of a given user's previous conditional orders that have matured into form orders.

A user who violates an ethical obligation, consistently breaches a code of conduct, or whose score on the scorecard falls below a minimum scorecard threshold level, may be blocked from participating in subsequent transactions with the exchange computer system 110. Scores from other venues can also be factored into the score of a user at the exchange computer system 110. Thus, if a user has a poor score at another venue, the poor score can be factored into the score of the user and result is a poor score of the user at the exchange computer system 110.

Before a transaction is conducted or in response to receiving any order from a user, the exchange computer system 110 can check the score of the user and determine whether to accept or reject the order. If the user has a score below the minimum scorecard threshold level, the user can be blocked and a message can be sent to the user informing the user of the reason for the block. If the user has a score above the minimum scorecard threshold level, the exchange computer system 110 can proceed with subsequent operations such as the ones described below in FIG. 2. If the user was not previously listed in the scorecard, the conditional order engine 136 can create a new entry for the user and assign a neutral score to the user that is above the minimum scorecard threshold level.

The invitation generator 140 is configured to generate an invitation for a user to create a new firm order based on the terms set forth in an existing conditional order, as described in more detail below with respect to FIG. 2. In some implementations, the invitation generator 140 can generate the invitation in response to a signal received from the OMS 134 indicating that two conditional offers are a likely (potential) matched. The invitation generated by the invitation generator 140 can be a message transmitted through network 114 to user devices 116, 118, 120 or market participants 122. The message can be an electronic message or a printed message and can include terms from a conditional order that are to be used to generate a new firm order.

The risk management gateway 146 includes risk parameters for each market participant, including the first user and the second user. For example, each market participant can set a single order limit, a traded value limit, and a cumulative daily traded value limit. The risk management gateway 146 can be configured to cause a graphical user interfaces of user devices to display information pertaining to orders. If a conditional order or firm order meets or exceeds risk parameters set by a particular user, the conditional order engine can send a warning to that user, and can cancel that order, and/or prevent further orders from being executed.

The risk management gateway 146 can also include a fat-finger check, such that each conditional order is checked for typographical errors and accidental additions or omissions. In one example, based upon the risk parameters, the risk management gateway 146 may determine that an order for 100,000 shares of XYZ is an error, and should instead be 10,000 shares of XYZ. The risk parameters set by each user in the risk management gateway 146 substantially prevent mistakes generated at the conditional order from maturing into firm orders. As such, the risk management gateway 146 may communicate with various aspects of the exchange computer system 110, such as the conditional order engine (COE) 136, the rules database 142, storage 144, and the like.

As noted above, the implementation of conditional execution for transaction requests with the specified conditionals can improve the human-machine inter-operability of the exchange computer system 110 and networked computer systems (e.g., user devices 116, 118, and 120) such that human traders and non-human traders can seamlessly co-exist to boost participation while preserving fairness to both. As a form of access control, the implementations provide an open system that accommodates the diverging capabilities expected from human and non-human participants. For example, participants, regardless of a human trader (e.g., sponsored user) or a non-human trader (e.g., a subscriber) can enter passive conditional orders that allow the participant to send a potential order that sits uncommitted until the party is invited—and accepts—to “firm up” the order. This invitation to “firm up” is transmitted to the party when a contra liquidity is found, for example, on the exchange network. The contra liquidity can refer to an order for the underlying asset (e.g., a financial instrument) in reverse direction that meets the price limit and at least partially fulfills the volume of the conditional order. The order of contra liquidity may be a conditional order. Additionally or alternatively, the order of contra liquidity may be a firm order, for example, a market order. In the latter case, the subscriber, or the sponsor, has opted into the exchange network to reap the benefits of the conditional orders.

Implementations may improve the performance of a large-scale trading network, as measured in atomic execution of each transaction while preserving system-level fairness. As noted above, each conditional order may sit uncommitted, until the party is invited—and accepts—to “firm up” the order. When a contra liquidity has been identified, the implementations use synchronized communication to transmit the invitation back to the party who placed the conditional order to firm-up. In this synchronized communication, the exchange network may wait for the party of the conditional order to respond so that no other party may access the identified contra liquidity in the interim. Because human traders and non-human (e.g., algorithm) traders vary in realistic responsiveness, implementations may use different time-out values. For example, when the communication is between a sponsored user (i.e., a human trader) and another sponsored user (i.e., another human trader), the time-out may be set at 30 seconds for both parties to firm-up. When the communication is between a subscriber (i.e., an algorithm trader) and another subscriber (i.e., another algorithm trader), the time-out may be set at 1 second for both sides. This differentiation of the time-out value for synchronized communication can ensure the contra liquidity is not over-committed and the trade, when executed, takes place over the available contra liquidity. In other words, the judicious implementation of the time-out mechanism, along with the use of synchronized communication, provide an atomic execution of the requested transaction, much like the transaction enforcement on a modern database management system (DBMS). For context, an atomic transaction in the database context refers to an indivisible and irreducible series of operations such that either all occurs, or nothing occurs, which prevents updates to the database occurring only partially, which can cause greater problems than rejecting the whole series outright. Here, atomicity is likewise achieved with respect to the identified contra liquidity. Moreover, the differentiation of time-out periods can accommodate both players so that market fairness can be achieved at the system level.

Further, COE 136 may implement a compliance mechanism for orders with conditional specification to mitigate information leakage while discouraging/minimizing potentially abusive conduct by a participant but without undermining fair access to the matching capabilities of the exchange network. For example, each subscriber (i.e., non-human algorithm trader) or sponsored user (i.e., human trader) that receives 10 or more invitations to firm up an order with a conditional specification for a given security needs to avoid crossing below, for example, a threshold level of firm-ups for that security. In many cases, the threshold may be around 70%. When a subscriber (i.e., non-human algorithm trader) or a sponsored user (i.e., human trader) fail this threshold level, the subscriber or sponsored user may be suspended from receiving invitations for new order with a conditional specification that the party enters for that security for the rest of that trading day. Notably, a fallen-down order with a conditional specification that originate with a sponsored user may not be attributed to the sponsor (e.g., a large brokerage company) for the conditional specification for purposes of calculating the sponsor's fall-down rate, but rather, these occurrences will be exclusively attributed to the sponsored user that entered the orders into the system. Moreover, COE 136 may report daily suspensions of subscribers (including which symbols were affected by the suspension) to a supervising agency and to each affected subscriber in real time, for example, via email, SMS, or other instant messaging tools. COE 136 may also report statistics of conditional execution to an oversight board, or the public.

Upon completion of a trade (through the floor in open outcry as entered into the PAR system, or through automatic execution through the OMS 134 and auction engine 136), the fill information is passed through the OMS 134 and the ORS 132 to one or more user devices 116, 118, 120, and 124, and to the trading engine 136. The trading engine 136 matches the buy side and sell side of a trade, and forwards the matched trade to a third party organization that verifies the proper clearance of the trade, such as the Options Clearing Corporation (OCC) where the securities may be options, or Depository Trust Company (DTC) where the securities may be equities. The OMS 134 also formats the quote and sale update information and sends that information through an internal distribution system that refreshes display screens on the floor, in addition to submitting the information to a quote and trade dissemination service such as, in the case of options, the Options Price Reporting Authority (OPRA). In the case of Equities, the information would be submitted to the Securities Information Processor (SIP).

FIG. 2 is a diagram of an example exchange computer system 200 with a conditional order engine (COE) 236 configured to set up transaction requests with conditional specifications so that the transaction requests can be executed electronically regardless of whether the transaction requests are initiated electronically by an algorithm, or by a human operator. While modern exchange network is replete with examples of using algorithmic trading (e.g., high-frequency trading), the ability to incorporate mechanisms to allow human operators to design, submit, and monitor transaction requests (such as sell orders, or buyer bids) would significantly improve the human-machine interactive aspect of an exchange network. For example, in the wake of flash crash induced by algorithmic trading when brokers employ highly similarly algorithms, a renewed focus on allowing human operators on the exchange network to conduct realistic transactions can improve the stability of the exchange network, thereby rendering the exchange network more robust and less prone to catastrophic flash crashes. Combined with the high-speed network and high throughput computer processors used by the exchange computer system 200, implementations of the present disclosure can preserve the agility in responding to transaction requests necessitated by the real-time nature of the market force, while injecting the much-needed stability to deter unwarranted flash crashes. The exchange computer system 200 may be implemented by software, hardware, or some combination as described herein. As an example, the exchange computer system 200 may be implemented as a server, a computer, or other device or processing component using proprietary software designed and implemented to achieve the functionality described herein. The exchange computer system 200 may be distributed or subdivided between a plurality of entities e.g., multiple computing devices.

The exchange computer system 200 may include a communication interface 202, coupled with a stock market data storage 204. The communication interface 202 may be communicatively linked to a trading engine 236, which includes a trading engine processor 208, trading engine data 210, and trading engine logic 212. The trading engine 236 may also be communicatively linked to an ordering matching system 234, an order routing system 232, a rules database 238, and storage 240 of the exchange computer system 200. The communication links in the exchange computer system 200 may be established by a system bus, network, or one or more other connection mechanisms. As an example, the connection mechanisms may include a wired connection, a wireless connection, or a combination thereof. For example, the connection may be a physical connection, such as a wired Ethernet connection. In another example, the connection may be a wireless connection, such as a cellular telephone network, an 802.11, 802.16, 802.20 controls or components, a WiMax network, or any other type of network. Further, network 214 may be a public network, such as the Internet, a private network, such as an intranet, or combinations thereof, and may utilize a variety of networking protocols now available or later developed including, but not limited to TCP/IP based networking protocols.

The trading engine processor 208 may include one or more processors, such as general-purpose processors (e.g., a microprocessor), special-purpose processors (e.g., an application-specific integrated circuit (ASIC) or digital-signal processor (DSP), programmable-logic devices (e.g., a field programmable gate array (FPGA)), or any other processor components now known or later developed. The trading engine processor 208 may carry out one or more instructions using one or more arithmetic, logical, and/or input/output operations. Though trading engine processor 208 is illustrated as a single component, trading engine processor 208 may be integrated in whole or in part with other components of the exchange computer system 200.

Data storage e.g., stock market data storage 204 and trading engine data 210, may be a main memory, a static memory, or a dynamic memory. Stock market data storage 204 and storage for trading engine data 210 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, organic storage components, and the like. As an example, the stock market data storage 204 and storage for trading engine data 210 may include a cache or random access memory for the trading engine processor 208. Stock market data storage 204 and storage for trading engine data 210 may be separate from the trading engine processor 208, such as a cache memory of a processor, the system memory, or other memory. Stock market data storage 204 and storage for trading engine data 210 may be an external storage device or database for storing data. Examples may include a hard drive, compact disc (“CD”), digital video disc (“DVD”), memory card, memory stick, universal serial bus (“USB”) memory device, or any other device operative to store data.

As further shown, COE engine 236 may include trading engine data 210 and/or trading engine logic 212. The trading engine data 210 may include one or more types of data suitable for a given implementation. For example, trading engine data 210 may include data (such as input datasets) that may be stored in memory. Trading engine logic 212 may include, for example, machine language instructions executable by trading engine 236 to carry out various functions, such as the functionality of the methods and systems described herein. In some implementations, the functions, acts or tasks may be independent of the particular type of instructions sets, storage media, processor or processing strategy and may be performed by software, hardware, integrated circuits, firm-ware, micro-code and the like, operating alone or in combination. Processing strategies may include multiprocessing, multitasking, parallel processing and the like.

In the exchange computer system 200, the communication interface 202 may include one or more structures, and associated equipment, for receiving data from one or more sources and distributing data to a group of one or more destinations. In some implementations, the communication interface 202 may include one or more additional communication interfaces and can operate in different configurations (e.g., distributed system, parallel). The communication interface 202 may be configured to receive input datasets from one or more entities (e.g., user devices or other exchanges) and store all or part of the input datasets in stock market data storage 204. The communication interface 202 may also be configured to communicate all or part of the input datasets to the trading engine 236 once the input datasets are stored or otherwise processed. The communication interface 202 may include a transceiver having one or more input/output ports connected to the network 214 to securely transmit data for one or more transaction requests with conditional specifications from the trading engine 236 to user computing devices. The communication may invoke a protocol that can include real-time, multicast, and duplex features so that participants (e.g., subscribers and sponsored users) can communicate in a non-stop and streaming manner. Examples of communications protocols may include the FIX (Financial Information exchange) session protocol, which has been described in more detail above.

As an example, the input datasets are stored in market data storage 204 may be partitioned (e.g., horizontal, vertical, functional) into designated memory locations (e.g., virtual addresses) based on qualities of the input datasets, e.g., a type of conditional specification, and a type of underlying asset. In some implementations, input datasets with data related to component stock options may be stored in market data storage 204 and include a linking identifier (e.g., address, memory mapping) to identify a corresponding stock for each of the component stock options. In some implementations, the market data storage 204 may be configured to receive an indicator describing the operating status (e.g., receiving, clearing, storing) of input datasets of the communication interface 202.

The input datasets from the communication interface 202 may include financial market data (e.g., market intelligence) corresponding to the underlying market conditions that drive the transaction requests. For example, financial market data may include volatilities, interest rates, dividends, returns (e.g., historical, expected), market capitalization, sector, prices, liquidity, and other metrics related to the underlying asset for which buyer bids and seller offers are received. Financial market data may also include measures, estimates, and other related data for options (e.g., calls, puts), futures, and other derivatives. The input datasets may also include corresponding log files to describe and store the financial market data e.g., a log file describing the transaction requests with conditional specifications. The log files may include metadata to tag or characterize data, e.g., corresponding time periods for which the data was recorded. For example, the log files may include a tag to be used for sorting or filtering the data of the log files.

Upon receiving input datasets from the communication interface 202, including data stored in the market data storage 204, the trading engine 236 may perform further processes including receiving requests and accessing metadata. The trading engine 236 may perform operations using the trading engine processor 208, with instructions stored in the trading engine logic 212, and data stored in trading engine data 210. The data stored in trading engine data 210 may include all of or a subset (e.g., filtered) of the data stored in market data storage 204, where the subset of the data stored in the trading engine data 210 is filtered based on a specified time period. The trading engine 236 may perform operations on the trading engine data 210 including deleting, archiving, tagging, and resetting. The trading engine 236 can utilize metadata, including log files, to process (e.g., filtering, sorting) the trading engine data 210.

The conditional order engine (COE) 236 may also access other components of the exchange computer system 200 including the order matching system 234, order routing system 232, rules database 238, and storage 240. The order matching system 234 may be configured to match an order received from the user device (e.g. user devices 116, 118, and 120) to another order based on the matching rules stored in the rules database 238. The order routing system 232 may be configured to route the order received from the user device to a destination associated with the order. The storage 240 may include additional data from the exchange computer system 200, accessed by the trading engine 236 for processing.

As noted above, the exchange computer system 110 can securely transmit information related to transaction requests with conditional specifications based on data received over successive periods of time to connected user computing devices (e.g., user devices 116, 118, 120) that are themselves configured to display the information. The information may be displayed, for example, within a graphical user interface of an application that facilitates continuous real-time generation of transaction requests with conditional specifications, as well as trading and settlement of an underlying asset through the exchange computer system.

FIG. 3A is an illustration of an exemplary graphical user interface on a device 310 for obtaining user inputs that determine data related to a transaction request with a conditional specification. A client device (e.g., user devices 116, 118, and 120) can, for example, provide the graphical user interface after receiving a user input indicating interest in placing an order. A user of a device 310 can interact with a user interface panel 320 created by the device 310 after receiving data (e.g., trading engine data 210) from the exchange computer system by a computer network (e.g., network 214). The user interface panel 320 can include fields that enable a user to enter a symbol (e.g., a stock or option symbol), select the type of the trade and specify an amount. As an example, the user can enter a symbol (e.g., “ASET”) corresponding to an underlying asset and generate a transaction request (e.g., buy or sell order, a call or put option) through the device 310.

The user interface panel 320 can include fields that enable a user to enter a symbol for an underlying asset corresponding to the underlying asset (e.g., a stock symbol). The user interface 320 can also include fields that enable a user to select a quantity of underlying asset, a direction of movement of the value of the asset, an expiry, and a frequency, e.g., a number of reset periods, a fixed reset period to determine the number of reset periods. For example, the user of the device 310 can specify a symbol in field 330 and a quantity of shares in field 340. The user of device 310 can also specify a price limit 350a (e.g., buy or sell), a request volume 350b (e.g., number of shares or options), and a type of the order 350c (e.g., buy or sell) of the transaction request. Alternatively, or in addition, the graphical user interface may be configured to pose a series of questions to the user, in which case inputs may be provided by the user through the graphical user interface as corresponding answers to the series of questions.

After the user has entered necessary data and selected generate combo button 370, data related to the requested transaction is provided to the exchange computer system, which generates the transaction request. The exchange computer system can, for example, log a transaction request based on a value of the underlying financial asset, a volume of the requested underlying financial asset, and a type of the transaction request for the underlying asset. For example, the exchange computer system can generate the requested transaction as a series of free-rolling contracts with each of the contracts having an equal time to expiry.

The disclosed systems and related user interfaces simplify the creation of a transaction request with a conditional specification by enabling users to specify, for example, the conditions in terms of natural language. For example, a user of device 310 may specify a price limit, a quantity, a type of fulfillment, and an expiration time. The expiration can be entered or described in terms of hours, days, weeks, months, years (e.g., “by noon”, “today”, “tomorrow”, “this week”, “next week”, “one week from today,” “two weeks from Friday”, “this March”, “next August”, and so on). The type of fulfillment can include pegging the price in the middle of the bid and offer (i.e., Peg Mid), pegging the price to bid when buying, or to the Offer when selling (i.e., Near-side Peg), pegging to the Offer when buying, or to the Bid when selling (i.e., Far-side Peg), or allowing a peg order a level of discretion as set on an order-by-order basis (i.e., Peg Offset).

The user interface panel 320 may receive a series of data related to financial instrument values over successive periods of time, and the manner in which the user interface panel 320 displays these values and/or related data may be customizable based on user preferences or other parameters. As an example, the information displayed in user interface panel 320 may be customized to include both numerical and/or graphical representations of past, present, and/or projected values of the electronic objects, for example, financial instruments which can be real or virtual documents representing any kind of monetary value. Specific examples of a financial instrument can include equity-based stock, option, non-fungible token (NFT), as well as debt-based collateral, lien, or security interest. The user interface panel 320 may additionally be customized to display information regarding present, past, and/or projected activities based on values (e.g., trading of financial instruments based on the transaction request with the conditional specification). For example, the user interface panel 320 may optionally display values of, and activity related to, financial instruments, including underlying assets and/or derivatives.

The manner in which user interface panel 320 displays information may also vary depending on other parameters. For example, the computational resources of the user devices connected via network 114 to the exchange computer system 110 can vary greatly, and the user interface panel 320 may be adapted for display on each particular user device based on parameters associated with that device (including screen size, display resolution, processing speed, and available bandwidth). For instance, a user operating a PC may benefit from display of a larger amount of information, whereas a user interacting with the exchange via a smart phone might benefit from a more streamlined presentation of information, which can be adjusted in response to user pinch actions on the touch screen of the smart phone. As another example, where bandwidth or processing resources are limited, user interface panel 320 can be configured to display information in less resource-intensive ways (e.g., through simplified graphics and text).

Various suitable types of panels 320 can be used to enter order information and additional information from a user. For example, inputs may be provided by a user as entries in fields (e.g., 330, 340, 350a, 350b, 350c), or as selections of buttons (e.g., 370) displayed within the graphical user interface. Alternatively, or in addition, the graphical user interface may be configured to pose a series of questions to the user, in which case inputs may be provided by the user through the graphical user interface as corresponding answers to the series of questions.

When placing a transaction request, a user may enter a ticker name, e.g., symbol, in field 330, for the underlying asset. The user may further enter information for the conditional specification 340 including, for example, a price limit 350a for the order, a number of shares 350a for the order, and a type 350c (e.g., buy or sell) by interacting the user interface panel 320. The conditional specification can further include the type of fulfillment including, for example, Peg Mid, Far-side Peg, Near-side Peg, and Peg Offset, as described above. In other words, the details of the conditional specification can be unique to each individual participant regardless of whether the individual participant is a human, or a non-human algorithm agent. Passive conditional orders can allow a party to send a potential order that sits uncommitted until the party is invited—and accepts—to “firm up” the order. This invitation to “firm up” is transmitted to the party when contra liquidity is found, for example, in the conditional book of the exchange network. Here, conditional orders may refer to orders to buy or sell a financial instrument when conditions specified by the user are satisfied. Conditional orders can include limit orders and stop orders. A limit order is an order to automatically buy or sell a financial instrument at a maximum bid price to be paid or at a minimum offer price to be received, as specified by the user. A stop order is an order to buy or sell when the financial instrument's market price has reached or surpassed the user's requested price. Limit orders and stop orders can be placed above and below the market price. Conditional orders disclosed herein can also prevent features or metrics of an order, such as price, volume, value, and the like from becoming known to users outside of a conditional order system. A conditional order may generally require a firm up to become a firm order that is no longer dependent upon a later confirmation by the market participant who has initiated the conditional order.

A graph 360 may display values for an underlying asset (e.g., a financial instrument for trading on open market) for a period of time (e.g., hours, 1 day, 30 days, 60 days, 1 year). The graph 360 can be provided to and displayed on the panel 320. The user of the device 310 may select additional display options (e.g., time windows, historical correlation data) for the graph 360. For example, in some cases, the range of the vertical axis can be dynamically arranged so that the present value of the underlying asset is maintained around the centerline of the display, which can be more advantageous for visualization purposes on panel 320. The graph 360 may display a series of values, e.g., prices, for an underlying asset over various time periods based on user customization. A generate button 370 is provided and displayed on the panel 320. After data has for an order has been selected by the user via the user prompts, the generate button 370 may be used to transmit the data to the exchange computer system 200 via the network 214. For example, the user interface panel 320 may display a limit price, a volume, and a type of the transaction request (e.g., buy or sell order).

FIG. 3B is an illustration of an exemplary graphical user interface on a device 310 for obtaining user inputs that determine whether to firm up a transaction request with a conditional specification. A user interface panel 320 created by the device 310 can prompt the user of the device 310 after receiving from the exchange computer system data encoding an invitation. As illustrated, the user interface panel 320 may project a prompt in the form of, for example, button 390, to query whether the user should firm up the previously placed transaction request (e.g., indicated by order 330A, conditional specification 340A) and along with graph 360 representing asset values of the underlying asset as a function of time. The user, upon reviewing the information of the previously placed transaction request and the temporal value of the underlying asset, may press button 390 to firm up the previously placed transaction request.

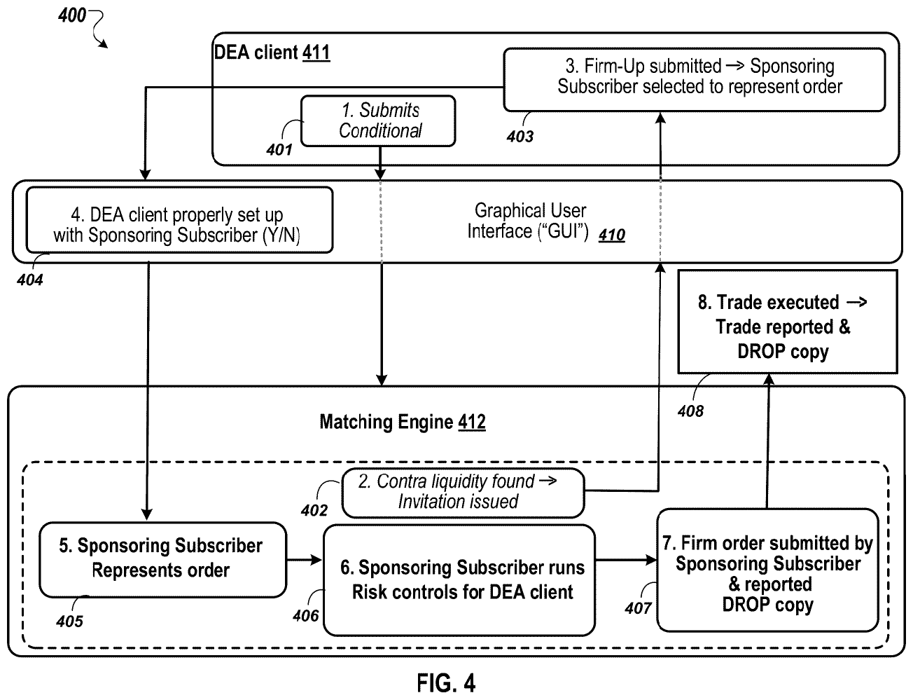

FIG. 4 shows a diagram 400 illustrating an example of a workflow according to some implementations of the present disclosure. As illustrated in 401, a participant may initially submit an order with a conditional specification (sometimes abbreviated as “conditional”). This submission may be performed on, for example, user devices 120, 118, and 116 of FIG. 1. The submitting party may be a human trader (e.g., a sponsored user), or a non-human algorithm trader (e.g., a subscriber). The submission may be handled by graphic user interface (GUI 410), which may reside on the user device. Example configurations of GUI 410 may be found in FIGS. 3A and 3B. GUI 410 may parse the information received from the participant into data for transmission over network 114 to exchange computer system 110.

The order with a conditional specification is then received at matching engine 412. An example of a matching system is provided in FIG. 1 as the exchange computer system 110 in which conditional order engine (COE) 136 may act in tandem with order matching system 134 and order routing system 132 to identify matching orders. The identification process may follow rules encoded by database 142. The identification may prioritize matches for a conditional order based on score information of the submitting participant, as stored in scorecard repository 138, which can be within storage 144. The identification may reveal the presence of a contra liquidity (e.g., an order placed in reverse direction of the conditional order) with sufficient volume and fitting price range to match the conditional order. For example, implementations may pursue priority matching based on, for example, the identifies of participants in a match. In some cases, COE 136 may prioritize matching orders from the same broker (e.g., traders from the same brokerage firm who is a sponsor of the conditional access model) over orders from different brokers. The price for execution in this scenario can be the mid-point of the two orders. When matching a conditional order with a market order, COE 136 may also prioritize matching orders from the same broker over those from different brokers. The price for execution in this scenario can be a minimal price improvement (e.g., smallest increment) over the market price so that both parties can achieve advantages from the trade. In other scenarios, for example, when matching a conditional order with liquidity providers with large quantities of marker orders, COE 136 may seek a protected price that is pre-determined while also prioritizing matching orders from the same broker over those from different brokers. In many cases, the protected price can favor the liquidity provider with large quantities of pending orders.

Matching engine 412 may exhibit additional salient features that are distinctive and unconventional. For example, shares are distributed among liquidity provide orders on a pro-rata basis. Orders with the same broker number may be preferentially matched before orders with different broker numbers. Anonymous orders can receive broker preference based on, for example, the underlying executing broker's identification number. The orders may be executed according to an algorithm that maximizes the share volume being traded. Matching engine 412 may adjust share distribution to achieve this goal, for example, by utilizing a pro-rata allocation method to reward size while maximizing participation among all liquidity providers.

Once a contra liquidity is identified, matching engine 412 may issue an invitation to the submitting participant (403). The invitation may be routed through GUI 410. FIG. 3A and FIG. 3B provide use case examples of a user providing a submission to matching engine 412 and a reply to an invitation from matching engine 412. As illustrated in FIG. 4, when a sponsoring subscriber, e.g., a brokerage firm with a group subscription to matching engine 412, is selected to represent the conditional order. In this case, a reply to the invitation would generally entail a binary choice of either yes or no. For example, a direct electronic access (DEA) client 411, who may have initially submitted the conditional order. The DEA client 411 can be a human trader, or a non-human algorithmic trader. In this illustration, when DEA client 411 is properly set up with the sponsoring subscriber (e.g., the brokerage firm with a group subscription), GUI 410 projects a prompt to the DEA client 411 so that the DEA client may firm up the invitation (fsu). For example, the DEA client may choose to either confirm or reject the invitation. As described above, each DEA client may operate with a limit on how many invitations the DEA client may reject (e.g., less than 70% rejection on a given day) so that abuse of matching engine 412 can be substantially reduced and information leakage can be mitigated to maintain fair access by all participants to the matching engine 412. GUI 410 may then package the reply from DEA client 411 for transmission to matching engine 412.

As illustrated in FIG. 4, when the matching engine receives the reply from GUI 410, the sponsoring subscriber may represent the conditional order (405). When vouching for the conditional order, for example, when the DEA client firms up the conditional order, the sponsoring subscriber may run risk controls on behalf of the DEA client (406). FIGS. 1 and 2 illustrate use case examples of risk controls, which can include, for example, fat-finger checks, single order limits, daily open orders plus traded value limits for buys, daily open orders plus traded value limits for sells; and gross daily orders plus traded value limits for buys and sells. These risk controls can be configured individually (e.g., when an individual human trader configures a rule set unique to this individual), or as a group (e.g., when the brokerage firm as a sponsoring subscriber provides a baseline rule set to everyone in the group). In some cases, the responsibility for setting and supervising the rule set for risk control may remain with the sponsoring subscriber who has the flexibility to configure risk controls in a unique manner for each of the sponsored users, as the sponsoring subscriber deems better suited to a particular setting.

When the sponsoring subscriber identifies no anomaly under the rule set of risk controls, the sponsoring subscriber may submit the firm order (i.e., original conditional order with the subsequent firm-up) and report the submission (407). For example, the report may be submitted to an oversight board to retain a record copy that can be used for auditing, statistical supervision, or simple bookkeeping. Once the firm order is materialized, the trade can be executed instantaneously so that the conditional order is fulfilled against the identified contra liquidity, as described above in association with FIGS. 1,2, 3A-3B.

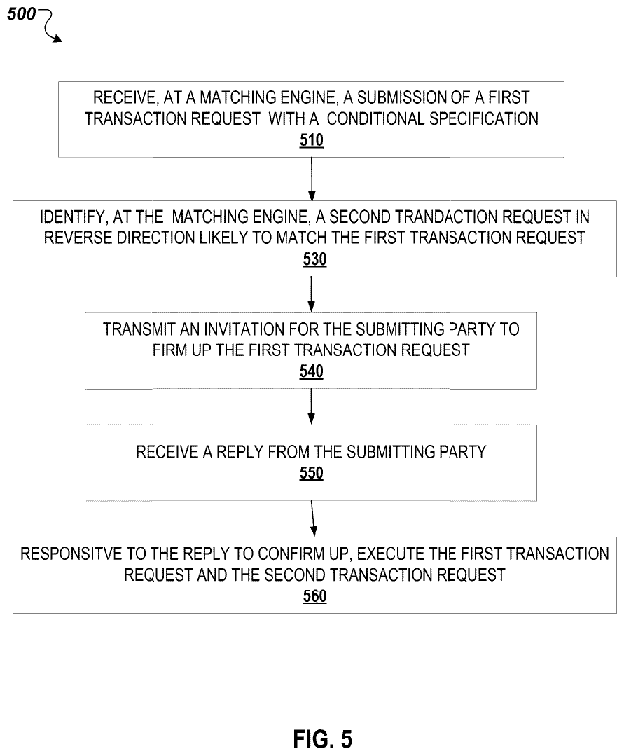

FIG. 5 is a flowchart of an exemplary process 500 for providing access to conditional order on an exchange network so that human traders and non-human traders can co-exist on the same electronic exchange market. The exchange network may also be referred to the exchange computer system, which may, for example, include at least one communication interface that is configured to receive, from one or more remote computing devices connected to the exchange computer system via a computer network, data related to one or more financial instruments. The exchange computer system may also include at least one non-transitory computer-readable medium configured to store the received data, and a trading engine having at least one hardware processor coupled with the at least one non-transitory computer-readable medium. The at least one non-transitory computer-readable medium may be further configured to store computer-executable instructions that when executed by the at least one hardware processor, cause the trading engine to perform various processes.

As illustrated, a matching engine may initially receive a user submission of a first conditional transaction request (510). In some cases, the conditional specification may correspond to a toggle which, once turned on, allows the submitting party to send a potential order for a financial instrument that sits uncommitted until the party is invited—and accepts—to “firm up” the conditional order. This invitation to “firm up” is transmitted to the submitting party when contra liquidity is found, for example, in the conditional book of the exchange network. As illustrated in FIGS. 3A and 3B, the submitting party can submit the conditional order involving a price limit, a requested volume, and an order type.

Flow chart 500 may then proceed to identify, at the matching engine, a second transaction request for exchanging the underlying financial instrument in the reverse direction that is likely to match the first conditional transaction request (530). In general, the exchange system can enforce rules so that the first conditional transaction request and the second transaction request do not originate from the same party. Given this generality, the second transaction request has a price and a volume that at least partially fulfill the requirement of the first conditional transaction request. In some cases, the prices of the first conditional transaction request and the second transaction request need not be identical. As described above, the type of fulfillment can be configured as: pegging the price in the middle of the bid and offer (i.e., Peg Mid), pegging the price to bid when buying, or to the Offer when selling (i.e., Near-side Peg), pegging to the Offer when buying, or to the Bid when selling (i.e., Far-side Peg), or allowing a peg order a level of discretion as set on an order-by-order basis (i.e., Peg Offset).

The matching engine may pursue a pro-rata allocation when, for example, three or more parties are involved in a match. In one illustration, the pro-rata matching algorithm may reward size while optimizing allocations to ensure maximum participation on every match. The pro-rata algorithm may begin with a pro-rata allocation and rounds all allocations up or down to the nearest board lot, as a strict pro-rata calculation would create. Odd-lot and fractional share allocations, which cannot be bought, sold, or settled, and which are therefore undesirable to market participants on the electronic exchange network. This pro-rata allocation may ensure that market participants are allocated board lot fills, and larger orders are rewarded with more shares to consummate. The remaining unallocated (residual) board lots (created aggregating the odd lots) may then be assigned to the largest order. This process allocates board lots to larger orders and works down the order size list. If there are multiple orders with the same size and not enough board lots to allocate, shares can be allocated on a time priority basis. After an initial round of pro-rata allocation, the residuals after rounding can be allocated to those orders in time priority that had been negatively affected by a rounding down in the first round of allocations.

With the second transaction request, a contra liquidity may be determined on the exchange network. When this happens, the matching engine may transmit an invitation to the party who has submitted the first conditional transaction request so that the submitting party is given the choice to firm up the first conditional transaction (540). As described above, various implementations aim at accommodating both human traders and non-human traders seamlessly on the same exchange network to boost participation and promote trading activities. Various mechanisms allow the exchange network to adapt to varying responsiveness of human traders and non-human traders so that both can participate with fairness to execute trades.

In various implementations, the matching engine may then receive a reply from the submitting party (550). For example, the submitting party may accept (known as “firm up”) the invitation so that the conditional transaction request becomes a firm order. The submitting party may also decline the invitation in case the submitting party changes mind (e.g., when market conditions alter significantly). However, declining the invitation may negatively impact the submitting party's score (e.g., as recorded by the scoreboard repository 138 in FIG. 1). As described above, the implementations are designed to discourage/minimize potentially abusive conduct when some participants intend to troll market trending information while pretending to submit conditional orders. However, to provide fairness to both human operators and non-human operators, the matching engine may implement distinct time-out periods for the two types of operators whose responsiveness vary significantly. The wait, or time-out periods, can advantageously allow participants to consider and accept, without requiring the participants to play statistical games while competing with each other at the risk of sometimes overcommitting and sometimes losing outright.

Responsive to the reply indicating that the submitting party firms up the first conditional transaction request, the matching engine may execute the first conditional transaction request and the second transaction request so that a trade can be consummated (560). As described above, the executing price can one of Peg Mid, Near-side Peg, Far-side Peg, Peg Offset, all of which are configurable. Matching engine may pursue a pro-rata allocation to boost participation and promote fairness. For example, the first conditional transaction request may only be partially fulfilled by the volume of allocated to the second transaction request. When this happens, the matching engine may search and identify a third transaction request as a likely match for the remainder of the first conditional transaction request. When the third transaction request is identified, matching engine may generate a new invitation for the submitting party to firm-up the remainder of the first conditional transaction request so that the submitting party has the opportunity to fully commit, like the illustrations in steps 530 to 560.

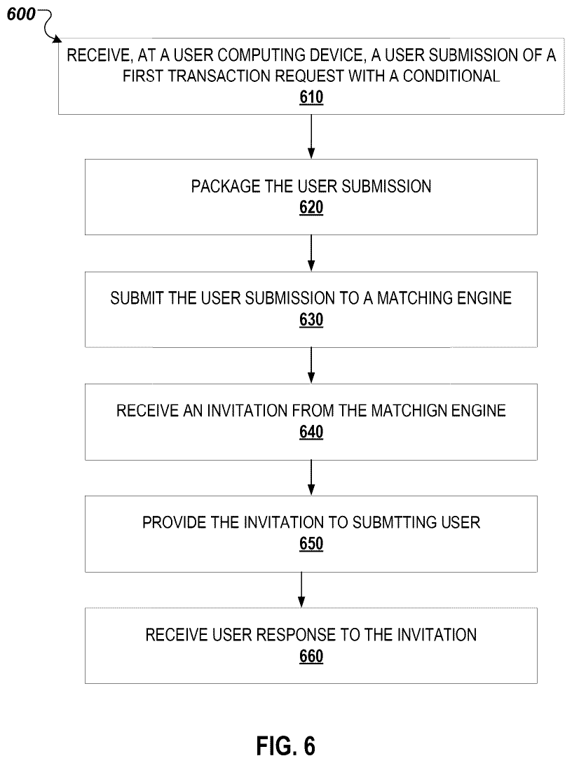

FIG. 6 is a flowchart of an exemplary process 600 for a user computing device of a user (e.g., a human operator) to assist the user in trading a financial instrument using conditional orders, as described above in association with FIGS. 1, 2, 3A-3B, and 4. Initially, the user computing device may receive a user submission of a first conditional transaction request (610). For example, the user computing device can include a graphic user interface (GUI) that packages the user input in the user submission (620) so that data encoding the user submitted conditional transaction request may be submitted to a matching engine (630). As described above, the matching engine may identify and determine a second transaction request as a likely match. When this happens, the user computing device may receive an invitation from the matching engine for the submitting user to firm-up the first conditional transaction request (640). Through the GUI, the user computing device may provide the invitation to the submitting user (650). The submitting user may then provide a response to the invitation on the GUI so that the user computing device receives the user response to the invitation (660). The user computing device may then package the user response into data encoding the reply to the invitation so that a reply is transmitted to the matching engine. As described above, matching engine may execute a trade represented by the first conditional transaction request and the second transaction request according to price fitting configurations and pro-rata allocations.

A number of implementations have been described hereinabove. It should however be understood that various modifications may be made without departing from the spirit and scope of the disclosure. For example, various forms of the flows shown above may be used, with steps re-ordered, added, or removed. Accordingly, other implementations are within the scope of the disclosure and claims.

Embodiments and all of the functional operations and/or actions described in this specification may be implemented in digital electronic circuitry, or in computer software, firmware, or hardware, including the structures disclosed in this specification and their structural equivalents, or in combinations of one or more of them. Embodiments may be implemented as one or more computer program products, e.g., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

Elements of a computer may include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer may not have such devices. Moreover, a computer may be embedded in another device, e.g., a tablet computer, a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT), liquid crystal display (LCD), or light emitting diode (LED) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while actions are depicted in the drawings in a particular order, this should not be understood as requiring that such actions be performed in the particular order shown or in sequential order, or that all illustrated actions be performed, to achieve desirable results. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. An exchange computer system comprising:
at least one communication interface connecting a plurality of remote computing devices with the exchange computer system, wherein at least one of the plurality of remote computing devices is configured to exchange one or more electronic objects using the exchange computer system;
a matching engine comprising at least one hardware processor, and at least one non-transitory computer-readable storage medium coupled to the at least one hardware processor and configured to store software instructions that, when executed by the at least one hardware processor, cause the matching engine to perform operations comprising:
receiving, from a remote computing device with a graphical user interface (GUI), data encoding a first conditional transaction request for exchanging the one or more electronic objects, wherein the GUI is configured to capture one or more user inputs by a submitting user that determine the data encoding the first conditional transaction request;
identifying, based on the first conditional transaction request for exchanging the one or more electronic objects, a second transaction request for exchanging the one or more electronic objects;
determining that the second transaction request is a likely match for the first conditional transaction request when the first conditional transaction request is at least partially met by the second transaction request;
transmitting, to the remote computing device, data encoding an invitation for the submitting user to firm up the first conditional transaction request; and
responsive to receiving, from the remote computing device, a reply to the invitation indicating that the submitting user firms up the first conditional transaction request on the GUI, executing the first conditional transaction request and the second transaction request such that the exchange computer system allows the submitting user to exchange the one or more electronic objects with the algorithm-driven software agent despite varied responsiveness.
